(19) United States
(12) Patent Application Publication
(10) Pub. No.: US 2024/0070632 A1
(43) Pub. Date: Feb. 29, 2024

(54) VIRTUAL ASSISTANT TRANSFERS

(71) Applicant: Truist Bank, Charlotte, NC (US)

(72) Inventor: Stephen Gary Hess, Palm Springs, CA (US)

(73) Assignee: Truist Bank, Charlotte, NC (US)

(21) Appl. No.: 17/894,758

(22) Filed: Aug. 24, 2022

(51) Int. Cl. G06Q 20/10; G06Q 20/40; G06Q 20/42

(52) U.S. Cl. CPC G06Q 20/108; G06Q 20/40145; G06Q 20/42

(57) ABSTRACT

A computer-implemented method includes receiving a request made by a user, via a virtual assistant interface of a remote user device, to transfer funds from a user account to an escrow account of an escrow service. The method also includes establishing a connection to the escrow service to transfer funds to the escrow account and validating, via the virtual assistant interface of the remote user device, authorization of the user to transfer funds from the user account. Additionally, the method includes transferring the funds from the user account to the escrow account. Further, method includes reporting to the user, via the virtual assistant interface of the remote user device, confirmation of transferring the funds to the escrow account.

### TECHNICAL FIELD

The present disclosure relates generally to virtual assistant operations and, more particularly (although not necessarily exclusively), to transfer operations using virtual assistant-based technology.

### BACKGROUND

Attempting to execute large financial transactions can be a cumbersome endeavor. Some large financial transaction may require certain in-person actions as a prerequisite, such as obtaining a cashier's check. In some instances, attempting to execute a large financial transaction may prompt restrictions from financial institutions. In such circumstances, financial institutions may implement restrictions without informing a customer or require verification before lifting the restrictions. Submitting verification to overcome the restriction may require additional burdensome tasks, such as navigating an automated telephone system. Despite the potentially onerous nature of executing large financial transactions, the obstacles exist for a reason. Fraudulent large financial transactions can be especially damaging to their victims.

### SUMMARY

In an example, a non-transitory computer-readable medium includes instructions that are executable by a processing device for causing the processing device to perform operations. The operations include receiving a request made by a user, via a virtual assistant interface of a remote user device, to transfer funds from a user account to an escrow account of an escrow service. The operations also include establishing a connection to the escrow service to transfer funds to the escrow account. Additionally, the operations include validating, via the virtual assistant interface of the remote user device, authorization of the user to transfer funds from the user account. Further, the operations include transferring the funds from the user account to the escrow account. Furthermore, the operations include reporting to the user, via the virtual assistant interface of the remote user device, confirmation of transferring the funds to the escrow account.

In an additional example, a computer-implemented method includes receiving a request made by a user, via a virtual assistant interface of a remote user device, to transfer funds from a user account to an escrow account of an escrow service. The method also includes establishing a connection to the escrow service to transfer funds to the escrow account and validating, via the virtual assistant interface of the remote user device, authorization of the user to transfer funds from the user account. Additionally, the method includes transferring the funds from the user account to the escrow account. Further, method includes reporting to the user, via the virtual assistant interface of the remote user device, confirmation of transferring the funds to the escrow account.

In an additional example, a system includes a processor and a non-transitory computer-readable medium including instructions that are executable by a processing device for causing the processing device to perform operations. The operations include receiving a request made by a user, via a virtual assistant interface of a remote user device, to transfer funds from a user account to an escrow account of an escrow service. The operations also include establishing a connection to the escrow service to transfer funds to the escrow account. Additionally, the operations include validating, via the virtual assistant interface of the remote user device, authorization of the user to transfer funds from the user account. Further, the operations include transferring the funds from the user account to the escrow account. Furthermore, the operations include reporting to the user, via the virtual assistant interface of the remote user device, confirmation of transferring the funds to the escrow account.

### BRIEF DESCRIPTION OF THE DRAWINGS

FIG. 1 is a block diagram of an example computing device, according to some aspects of the present disclosure.

FIG. 2 is an example of a user interface (UI) for a virtual assistant module, according to some aspects of the present disclosure.

FIG. 3 is a flow chart of an example of a process for performing a virtual assistant transaction, according to some aspects of the present disclosure.

FIG. 4 is a flow chart of an example of a process for providing account access, according to some aspects of the present disclosure.

### DETAILED DESCRIPTION

Certain aspects and examples of the present disclosure relate to transfer operations using virtual assistant-based technology. A virtual assistant may be a software application used to conduct a conversation via text, speech-to-text, or text-to-speech in place of or in addition to direct contact with a live human agent. A virtual assistant may interpret natural language provided by a user to navigate an algorithm that may be arranged to execute a plurality of possible outcomes.

A transaction customer may find themselves in a competitive real-estate market where houses are placed on the market and under contract in a limited amount of time. In such circumstances, the customer may desire securement of funds for an earnest money deposit as fast as possible to avoid losing a property they desire to another buyer. Human agents may not be instantly available to facilitate a transfer of funds from a customer's account to an escrow account. Even if a human agent is available, the human agent's ability to transfer funds may be slowed by obstacles such as navigating their own computer or transcribing account numbers read aloud by the customer. A virtual assistant may enable a customer to execute a transfer of earnest money to an escrow account in a manner more efficient than requesting the transfer through a human agent. A virtual assistant may also be a preferable means of interaction. For example, a customer may be able to maintain a face-to-face conversation with a seller's agent while requesting a transfer via a virtual assistant instead of stepping away to conduct a phone conversation with a human agent.

The virtual assistant may be programmed to respond to a plurality of requests. The customer may request, by written or spoken natural language, a deposit of earnest money into an escrow account. The virtual assistant may respond by requesting the name of the escrow service with which the customer wishes to make the deposit. The virtual assistant may provide an escrow service in the event the customer, the seller's agent, or other appropriate parties have not made the appropriate arrangements for an escrow account. The virtual assistant may request an account number to direct the deposit towards. In the event the account number is not available, the virtual assistant may be able to ascertain the appropriate account based on alternative information such as the name of the seller's agent's firm or the address of the real property for which the earnest money is being deposited. The virtual assistant may request the customer specify which account the customer would like to make the deposit from. The virtual assistant may enable the customer to specify contributions from a combination of accounts to satisfy the deposit. Any questions asked by the virtual assistant to the customer may be answered in typed natural language, spoken commands, or by selecting a graphical interface object such as a button, icon, or drop-down menu.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

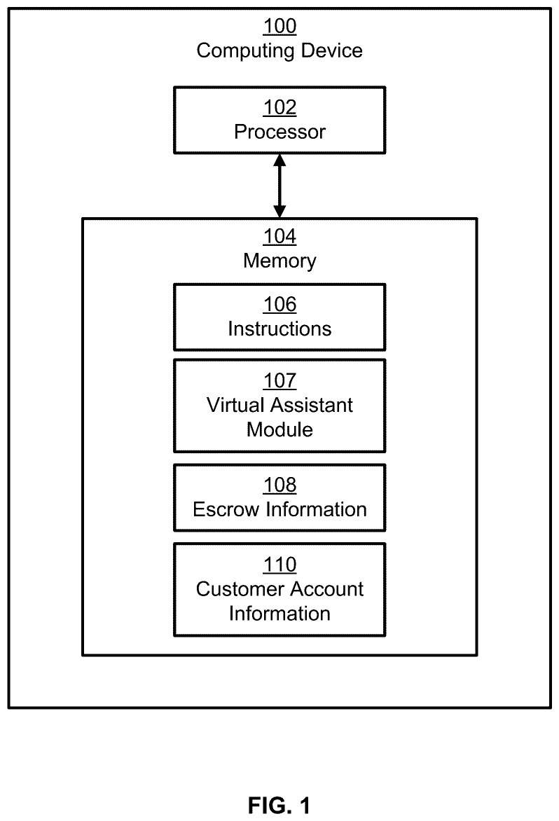

FIG. 1 is a block diagram of an example computing device 100 according to one example of the present disclosure. The computing device 100 includes a processor 102 that is communicatively coupled to a memory 104. In some examples, the processor 102 and the memory 104 may be distributed from (e.g., remote to) one another. The processor 102 can include one processing device or multiple processing devices. Non-limiting examples of the processor 102 include a Field-Programmable Gate Array (FPGA), an application-specific integrated circuit (ASIC), a microprocessor, etc. The processor 102 can execute instructions 106 stored in the memory 104 to perform operations. In some examples, the instructions 106 can include processor-specific instructions generated by a compiler or an interpreter from code written in a suitable computer-programming language, such as C, C++, C#, etc.

The memory 104 can include one memory or multiple memories. The memory 104 can be non-volatile and may include any type of memory that retains stored information when powered off. Non-limiting examples of the memory 104 include electrically erasable and programmable read-only memory (EEPROM), flash memory, or any other type of non-volatile memory. At least some of the memory 104 can include a non-transitory, computer-readable medium form which the processor 102 can read instructions 106. A computer-readable medium can include electronic, optical, magnetic, or other storage devices capable of providing the processor 102 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 106.

The memory 104 may also contain escrow information 108 and customer account information 110. Escrow information 108 may include information for transferring funds into an escrow account, such as the account number or the escrow service holding the account. Escrow information 108 may also include information related to finding an escrow service for the customer. Customer account information 110 may include information related to accessing the customer's account, such as account numbers and passwords. Customer account information 110 may also include information about the customer's account, such as account balances or holds on the customer's accounts.

The memory 104 may contain a virtual assistant module 107. The virtual assistant module 107 may guide a user through an algorithm related to an escrow transfer. The virtual assistant module 107 may guide a user through other algorithms related to other banking services, such as transfers, deposits, or inquiries about transactions. The virtual assistant module 107 may recognize natural language in the form of text or voice commands and assign inputs, such as numerical values or decision node values, to the natural language. Example decision node values may include a type of banking service requested by the virtual assistant module 107, such as a transfer, a deposit, or an inquiry about transaction.

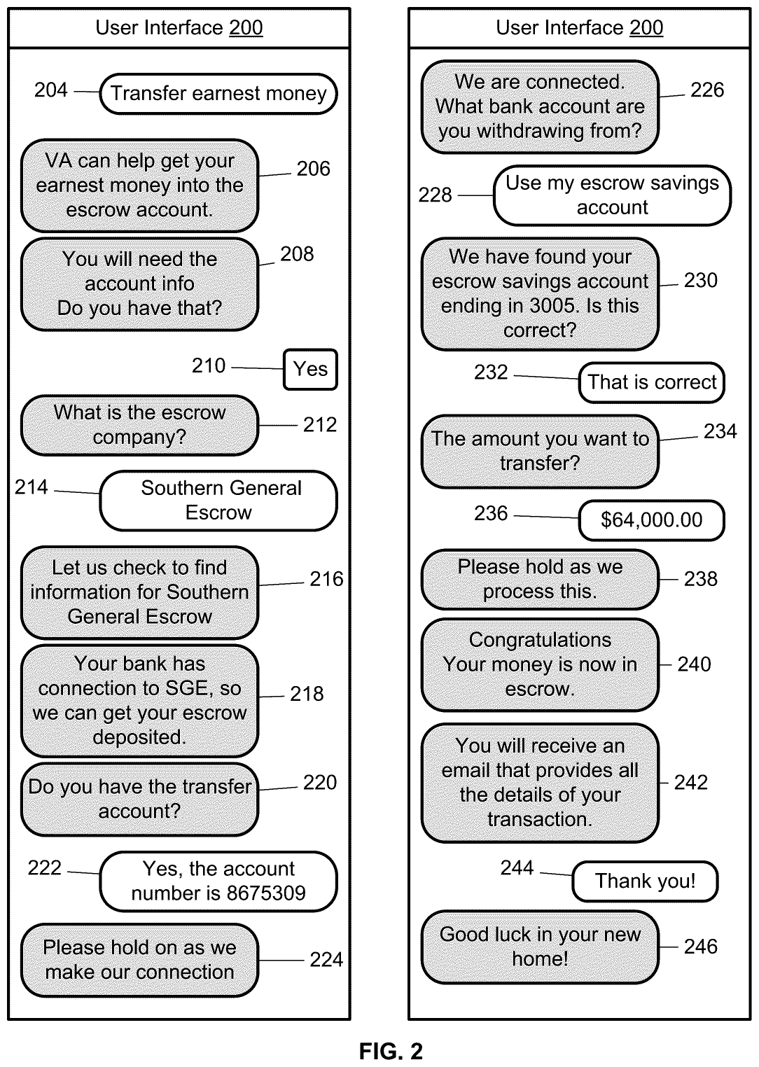

FIG. 2 is an example of a user interface 200 (UI) for a virtual assistant module 107, according to some aspects of the present disclosure. The user may request 204 a transfer of funds within the UI 200. The virtual assistant module 107 may respond 206, 208 with a query for relevant information. In the present example, the virtual assistant module 107 requests if the information is available, to which the user responds affirmatively 210. The virtual assistant module 107 requests 212 the name of an escrow company and the user responds with the name 214 of an escrow company. In other examples, the virtual assistant module 107 may respond with different statements or different questions based on a different request from the user, prior interactions with the user, or the user's personal financial information.

The virtual assistant module 107 informs 216 the user information related to the escrow company named by the user is being searched for. Messages of a similar character, which may update a user on a process without necessarily asking a question or providing information, can be helpful for demonstrating to the user a process is underway. The virtual assistant module 107 informs 218 the user that a connection exists between the user's bank and the escrow company. In other examples, the virtual assistant module 107 may respond by informing the user a connection may not be possible, requesting more information to better establish a connection for the user, or suggesting a different entity for the transfer.

The virtual assistant module 107 requests 220 a transfer account, to which the user responds 222 with an account number. The virtual assistant module 107 responds 224 that an attempt to connect to the escrow company is being made. In other examples, the user may respond with an invalid account number. In some such examples, the virtual assistant module 107 may respond by informing the user the account number is invalid and may reissue a request for an account number.

The virtual assistant module 107 requests 226 a user bank account from which to withdraw funds. The user responds 228 with an escrow savings account. In some examples, the user may have previously established a bank account explicitly accessible by the virtual assistant module 107. In some examples, the virtual assistant module 107 may be able to guide the user through a series of questions that may allow a user's bank account to become accessible to the virtual assistant module 107.

The virtual assistant module 107 confirms 230 the account specified by the user by displaying a portion of the account number. The user confirms 232 the account displayed is the correct account. The virtual assistant module 107 requests 234 the amount the user wishes to transfer from their account. The user responds 236 with an amount. The virtual assistant module 107 responds 238 that an attempt to transfer is being made, confirms 240 the success of the transfer, and informs 242 the user they will receive an email detailing the transaction. The user responds 244 to the virtual assistant module 107, prompting a response 246 from the virtual assistant module 107 that may be appropriate for the circumstances regarding the transfer.

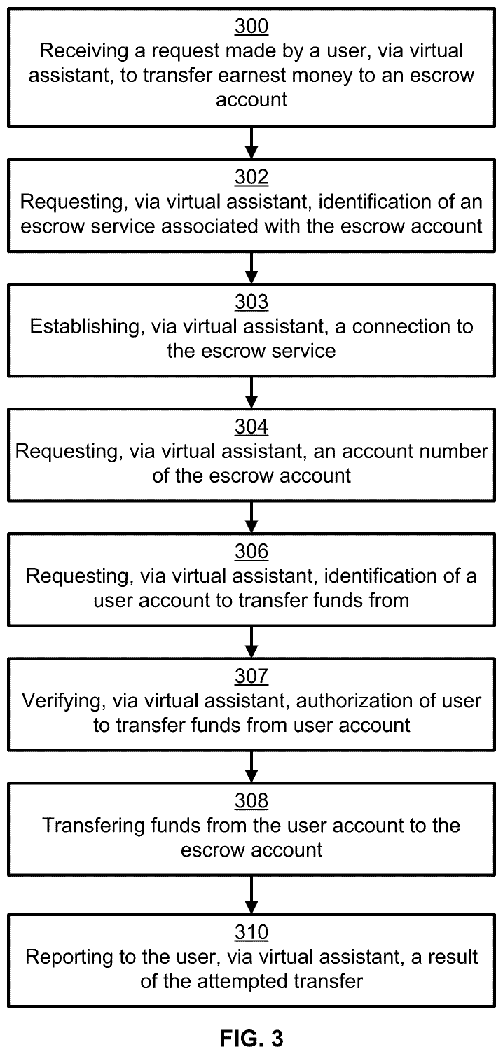

FIG. 3 is a flow chart of an example of a process for performing a virtual assistant transaction, according to some aspects of the present disclosure. In block 300, a computing device 100 may receive a request made by a user, via the virtual assistant module 107, to transfer earnest money to an escrow account. The earnest money may be for the purchase of real property. The earnest money may be for the purchase of a vehicle. The earnest money may be for any other suitable transaction. In some examples, the computing device 100 may respond to a request made by a user, via the virtual assistant module 107, to transfer funds other than earnest money to an escrow account. Example transfers of funds other than earnest money may be transferring funds into a settlement escrow account, pursuant to a court order.

In block 302, the computing device 100 may ask the user, via the virtual assistant module 107, to identify an escrow service associated with the escrow account. In some examples, the computing device 100 may consult stored escrow information 108 to provide the user with an escrow service. The escrow information 108 may be able to provide an escrow service based on at least one question posed to the user, via the virtual assistant module 107, about the nature of the earnest money transfer request. For example, the virtual assistant module 107 may ask the user to identify a buyer's agent, a seller's agent, real estate firms of the buyer's agent or the seller's agent, an address of the real property being purchased, or other information pertinent to providing an appropriate escrow service. The computing device 100 may store the escrow service provided to the user or provided by the user within the escrow information 108.

In block 303, the computing device 100 may establish, via the virtual assistant module 107, a connection to the escrow service. The connection may depend on a history between the bank of the user and the escrow service. The connection may be encrypted.

In block 304, the computing device 100 may ask the user, via the virtual assistant module 107, for an account number of the escrow account. In some examples, the computing device 100 may provide an escrow account number when providing an escrow service. The account number may be stored within the escrow information 108. Upon receiving the escrow account number, the computing device 100 may have sufficient information to ask the user, via the virtual assistant module 107, questions regarding terms of the earnest money transfer. The virtual assistant module 107 may ask whether the user will waive a clawback provision. A clawback provision may allow the user to recover their earnest money in some situations. For example, a clawback provision may allow a user to recover their earnest money if a house they are in the process of purchasing does not pass an inspection. The virtual assistant module 107 may ask the user whether the funds held in escrow can be invested.

In block 306, the computing device 100 may ask the user, via virtual assistant module 107, to identify a user account from which to transfer the funds. For example, the virtual assistant module 107 may ask the user to select a checking account or a savings account. In some examples, the virtual assistant module 107 may simply ask the user which account they would like to withdraw from, and the user can respond by naming the account. The computing device 100 may have information related to the user's accounts stored in customer account information 110. In such an example, the user may not need to name the exact account number or perfectly describe the account. The user may only need to sufficiently describe the account. For example, the user may respond “savings account” to describe a money market savings account. The virtual assistant module 107 may ask clarifying questions if the response is unclear. The virtual assistant module 107 may ask for authenticating information related to the account identified by the user if the account has a hold or other restriction currently applied to it. The virtual assistant module 107 may ask for authenticating information for other suitable reasons.

In block 307, the computing device 100 may verify, via the virtual assistant module 107, authorization of the user to transfer funds from the user account. In an example, verifying the authorization of the user may include evaluating transfer rules associated with the user account to confirm that the transfer is authorized and confirming an identity of the user through the virtual assistant module 107. Rules associated with the user account may include a maximum dollar amount for an individual transfer, an indication of users that are authorized to transfer money from the user account, an indication that funds from the user account can or cannot be used in an earnest money transfer, an indication that the virtual assistant module 107 is able to initiate a funds transfer from the user account, any combination thereof, or any additional rules that may be relevant.

Additionally, the identity of the user may be confirmed through a biometric screening performed on the user through the virtual assistant module 107. For example, the biometric screening can include voice verification, electronic signature verification, image verification, or a combination thereof. When the user identity is confirmed, and the user account rules indicate that the user is authorized to perform the transfer, then the transfer of funds to the escrow account may be attempted.

In block 308, the computing device 100 may attempt to transfer funds from the account identified by the user to the escrow account that was either provided by the user or provided to the user. The computing device 100 may transfer funds if the user has a sufficient balance, has accepted the terms of the earnest money transfer, or if other conditions are met. The computing device 100 may not transfer funds from the account identified by the user if certain conditions are not met, such as insufficient funds or rejected terms.

In block 310, the computing device 100 may report to the user, via virtual assistant module 107, the results of the attempted transfer from block 308. The virtual assistant module 107 may report a successful transfer if the transfer was successful or report a failed transfer if the transfer was unsuccessful. The virtual assistant module 107 may report a reason for the transfer failing. Example reasons for a failed transfer may be insufficient funds, a server timeout, or a loss of a secure connection.

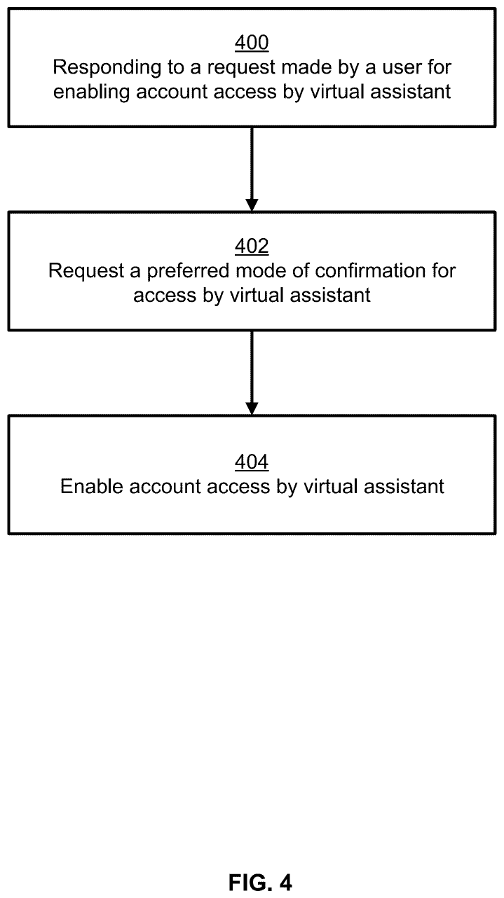

FIG. 4 is a flow chart of an example of a process for providing account access, according to some aspects of the present disclosure. In block 404, a computing device 100 may respond to a request made by a user for enabling account access by a virtual assistant module 107. The request may be for enabling access to a checking account, a savings account, a money market account, a certificate of deposit account, or any other suitable account. The request may be for enabling access to an account created for a specific purpose. For example, the request may be for enabling access to an account with the express purpose of holding earnest money for transfer into an escrow account. The request may be for enabling access to a line of credit, such as a credit card. The request may be for enabling access to an investment account, such as a 401(k) or an individual retirement account. The request may be for enabling access to an account unrelated to banking, such as an account associated with a utility company, an internet service provider, or an online gaming account. The computing device 100 may respond by providing the user with instructions necessary to permit account access to a virtual assistant module 107. For example, the computing device 100 may ask the user security questions, request personal information from the user, or connect the user with a live agent.

In block 402, the computing device 100 may request a preferred mode of confirmation for access by the virtual assistant module 107. The preferred mode of confirmation may be employed when the user attempts to access the account by virtual assistant module 107. For example, the user may inform the computing device their preferred mode of confirmation is facial recognition, biometric scan, a password, a voice password, a gesture password recognized by a touchscreen, or any other suitable mode of confirmation.

In block 404, the computing device 100 may enable account access by the virtual assistant module 107. After this step, the user may be able to access their specified account by the virtual assistant module 107.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A non-transitory computer-readable medium comprising instructions that are executable by a processing device for causing the processing device to perform operations comprising:
receiving a request made by a user, via a virtual assistant interface of a remote user device, to transfer funds from a user account to an escrow account of an escrow service;
establishing a connection to the escrow service to transfer funds to the escrow account;
validating, via the virtual assistant interface of the remote user device, authorization of the user to transfer funds from the user account;
transferring the funds from the user account to the escrow account; and
reporting to the user, via the virtual assistant interface of the remote user device, confirmation of transferring the funds to the escrow account.

2. The non-transitory computer-readable medium of claim 1, wherein the operation of validating the authorization of the user to transfer funds from the user account comprises:
evaluating transfer rules associated with the user account to confirm that the transfer is authorized; and
confirming an identity of the user through the virtual assistant interface.

3. The non-transitory computer-readable medium of claim 2, wherein confirming the identity of the user through the virtual assistant interface comprises performing a biometric screening on the user through the virtual assistant interface, wherein the biometric screening comprises voice verification, electronic signature verification, image verification, or a combination thereof.

4. The non-transitory computer-readable medium of claim 3, wherein evaluating the transfer rules comprises determining that the user is authorized to perform the transfer based on the confirmed identity of the user.

5. The non-transitory computer-readable medium of claim 2, wherein the transfer rules associated with the user account comprise authorization for the funds in the user account to be transferred to the escrow account.

6. The non-transitory computer-readable medium of claim 1, wherein the operation of validating the authorization of the user to transfer the funds from the user account comprises confirming an identity of the user to overcome a hold in place on the user account.

7. The non-transitory computer-readable medium of claim 1, wherein the funds comprise earnest money for a purchase of real property.

8. A computer-implemented method, comprising:
receiving a request made by a user, via a virtual assistant interface of a remote user device, to transfer funds from a user account to an escrow account of an escrow service;
establishing a connection to the escrow service to transfer funds to the escrow account;
validating, via the virtual assistant interface of the remote user device, authorization of the user to transfer funds from the user account;
transferring the funds from the user account to the escrow account; and
reporting to the user, via the virtual assistant interface of the remote user device, confirmation of transferring the funds to the escrow account.

9. The method of claim 8, wherein validating the authorization of the user to transfer funds from the user account comprises:
evaluating transfer rules associated with the user account to confirm that the transfer is authorized; and
confirming an identity of the user through the virtual assistant interface.

10. The method of claim 9, wherein confirming the identity of the user through the virtual assistant interface comprises performing a biometric screening on the user through the virtual assistant interface, wherein the biometric screening comprises voice verification, signature verification, image verification, or a combination thereof.

11. The method of claim 10, wherein evaluating the transfer rules comprises determining that the user is authorized to perform the transfer based on the confirmed identity of the user.

12. The method of claim 9, wherein the transfer rules associated with the user account comprise authorization for the funds in the user account to be transferred to the escrow account.

13. The method of claim 8, wherein validating the authorization of the user to transfer the funds from the user account comprises confirming an identity of the user to overcome a hold in place on the user account.

14. The method of claim 8, wherein the funds comprise earnest money for a purchase of real property.

15. A system comprising:
a processor; and
a non-transitory computer-readable medium comprising instructions that are executable by a processing device for causing the processing device to perform operations comprising:
receiving a request made by a user, via a virtual assistant interface of a remote user device, to transfer funds from a user account to an escrow account of an escrow service;
establishing a connection to the escrow service to transfer funds to the escrow account;
validating, via the virtual assistant interface of the remote user device, authorization of the user to transfer funds from the user account;
transferring the funds from the user account to the escrow account; and
reporting to the user, via the virtual assistant interface of the remote user device, confirmation of transferring the funds to the escrow account.

16. The non-transitory computer-readable medium of claim 15, wherein the operation of validating the authorization of the user to transfer funds from the user account comprises:
evaluating transfer rules associated with the user account to confirm that the transfer is authorized; and
confirming an identity of the user through the virtual assistant interface.

17. The non-transitory computer-readable medium of claim 16, wherein confirming the identity of the user through the virtual assistant interface comprises performing a biometric screening on the user through the virtual assistant interface, wherein the biometric screening comprises voice verification, signature verification, image verification, or a combination thereof.

18. The non-transitory computer-readable medium of claim 17, wherein evaluating the transfer rules comprises determining that the user is authorized to perform the transfer based on the confirmed identity of the user.

19. The non-transitory computer-readable medium of claim 16, wherein the transfer rules associated with the user account comprise authorization for the funds in the user account to be transferred to the escrow account.

20. The non-transitory computer-readable medium of claim 15, wherein the operation of validating the authorization of the user to transfer the funds from the user account comprises confirming an identity of the user to overcome a hold in place on the user account.
